(19) United States
(12) Patent Application Publication
(10) Pub. No.: US 2004/0028326 A1
(43) Pub. Date: Feb. 12, 2004

(54) Parabolic pulse communication system and method

(76) Inventors: Martin E. Fermann, Ann Arbor, MI (US); Benn C. Thomsen, Auckland (NZ); Vladimir I. Kruglov, Auckland (NZ); John M. Dudley, Auckland (NZ); John D. Harvey, Auckland (NZ)

Correspondence Address: SUGHRUE MION, PLLC, 2100 PENNSYLVANIA AVENUE, N.W., WASHINGTON, DC, 20037, US

(21) Appl. No.: 10/275,137

(22) PCT Filed: May 8, 2001
(86) PCT No.: PCT/NZ01/00077

(51) Int. Cl. G02B 6/26; G02B 6/42

(52) U.S. Cl. 385/31

(57) ABSTRACT

The invention provides a method of communicating between two devices performed by transmitting a series of pulses over an optical medium between the first device and the second device, the method including amplifying the pulses in an optical amplifier having a characteristic generally described by the NLSE with gain to yield parabolically shaped pulses.

### FIELD OF INVENTION

The invention relates to high speed optical communication systems.

### BACKGROUND

In optical communications systems the transmitted signal degrades during transmission over distances due to spreading out and overlapping of the individual pulses that make up the signal via dispersive broadening. Pulses sent with high power also tend to disintegrate a phenomenon known as “optical wave breaking” in the normal dispersion regime. Repeaters are used to raise the power level of the signal pulses and reshape the pulses and frequently also retime the pulses. Raising the power level is required due to the attenuation suffered by the signal in the optical fiber, reshaping is required due to spreading, and retiming is often necessary to maintain proper pulse spacing. Repeaters in fiber telecommunication typically comprise a means for detecting the signal, eg a photodiode, means for operating on the output of the photo detector, eg amplifying and reshaping the electrical output signal of the detector, and a source for optical radiation, modulated typically by the amplifier and reshaped output signal of the detector, as well as means for again coupling the output of the optical source into the fiber. In a long distance communication system the cost of repeaters is significant. Any reduction in the number of repeaters required will reduce the cost of the long distance fiber optic communication system for end users.

In monomode fiber ie fiber in which only the fundamental mode of the signal can propagate at the operating wavelength of the system, the two principal dispersion mechanisms are material dispersion and waveguide dispersion. A material of index of refraction n exhibits material dispersion at the wavelength A if d²n/dλ²=0 at that wavelength. Physically, this implies that the phase velocity of a plane wave travelling in such a medium varies nonlinearly with wavelength, and consequently a light pulse will broaden as it travels through such medium. Waveguide dispersion typically also is wavelength dependent. We will refer herein to the combined material and waveguide dispersion as “chromatic” dispersion.

If in a medium d²n/dλ²>0 throughout a certain wavelength regime, then the medium is said to be normally dispersive in that regime. On the other hand, a wavelength regime throughout which d²n/dλ²<0 constitutes a so-called anomalous dispersion regime. Separating the two regimes is a wavelength at which d²n/dλ²=0 ie at which material dispersion is zero to first order. This wavelength depends on the composition of the medium. The wavelength at which chromatic dispersion vanishes to first order similarly is composition dependent and, in addition, depends on such fiber parameters as diameter and doping profile. It can, for instance, be as high as about 1.5 μm in appropriately designed monomode silica-based fibers. A natural choice of carrier wavelength in a high data rate fiber telecommunication system is the wavelength of first-order zero chromatic dispersion in the fiber. However, even at this wavelength, pulse spreading occurs due to higher order terms in the dispersion.

In the anomalous dispersion regime the balance of dispersive broadening and nonlinear effects can be used to transmit data using optical solitons. In this case the maximum power that can be transmitted is limited to that required to achieve this balance. See for example U.S. Pat. No. 4,558,921. More recently it has been proposed that a “dispersion managed” fiber link be used to transmit data in the nonlinear regime (where nonlinear optical effects are important). There is still a limit to the energy of the data pulses that can be transmitted in such a dispersion managed system set by the required balance between dispersion and nonlinearity.

The evolution of ultrashort pulses in an optical amplifier described by the non-linear Schrodinger equation (NLSE) with gain may be given by:

$$i \frac{\partial A}{\partial z} = \frac{1}{2} {β}_{2} \frac{{\partial }^{2} A}{\partial {T}^{2}} - γ {\vert A \vert}^{2} A + i \frac{g}{2} A . \qquad ( 1 )$$

Here A(z,T) is the slowly varying pulse envelope in a co-moving frame, β₂ is the group velocity dispersion (GVD) parameter, γ is the nonlinearity parameter and g is the exponential gain coefficient. In the absence of gain (g=0), it is possible to solve the NLSE exactly using the inverse scattering method to obtain the well-known soliton solutions but, in the presence of gain, solutions to the equation usually require numerical simulations.

### SUMMARY OF INVENTION

In broad terms in one aspect the invention comprises a method of communicating between two devices including transmitting a series of pulses over an optical medium between a first device and a second device including amplifying the pulses in an optical amplifier having a characteristic generally described by the NLSE with gain to yield parabolically shaped pulses.

In broad terms a another aspect of the invention comprises a method of optical communication including providing pulses to the input of an optical source having an output characteristic generally described by the NLSE with gain such that parabolic output pulses are formed and coupling the amplifier to the input end of an optical communications medium and allowing the pulses produced by the optical amplifier to propagate along the optical fiber to at least one amplifier, regenerator or receiver. The energy provided in the input pulses is modulated to vary the amplitude and period of the output pulses.

In broad terms in another aspect the invention comprises a pulse generator having a characteristic generally described by the NLSE with gain arranged to generate parabolic output pulses from incident pulses.

In broad terms in another aspect the invention comprises an optical amplifier having a characteristic generally described by the NLSE with gain arranged to generate parabolic output pulses from incident pulses.

The parabolic pulses produced by the optical amplifier of the invention may be easily compressed as a consequence of their strictly linear chirp.

In one form the method and system of the invention includes transmitting a pulse of electromagnetic radiation, of carrier wavelength λₒ, through a fiber communication channel, the channel comprises single mode optical fiber, with λₒ being a wavelength in the anomalous dispersion regime of the fiber. The pulses are amplified and transmitted such that parabolic pulses are formed and propagate.

Examples of non-electronic amplifiers include glass amplifiers ie a glass medium, typically a fiber, doped with an appropriate ion species (that is, ions having energy levels separated by an energy substantially equal to hc/λₒ, where h is Planck's constant and c is the speed of light in vacuum), and pumped with electromagnetic radiation adapted to producing a population inversion in the energy levels; Raman amplifiers eg a glass medium, typically a fiber, in which λₒ is within a “Stokes” wavelength band of a pump radiation; injection of a continuous wave (cw) of wavelength essentially equal to λₒ, in phase with the parabolic pulse and of amplitude substantially lower than the pulse amplitude, whereby, through nonlinear interaction between pulse and cw, a pulse amplitude increase can result; and a semiconductor laser operated as an amplifying medium. The above are examples of amplifying means in which the signal is at all times present in the form of a photon pulse, and is never present as an electron pulse, and which permit preservation of the phase of the pulse.

It will be appreciated that a parabolic pulse does not retain a constant shape and pulse height but rather, the pulse typically undergoes a change of pulse width and amplitude while it propagates through the fiber after having undergone amplification to attain its parabolic shape. In view of the linear chirp which the pulses develop, various dispersion compensation compressors can be used to recompress the pulses.

In broad terms in another aspect the invention comprises an optical telecommunication system comprising:

(a) a source of pulses of electromagnetic radiation of carrier wavelength λₒ;

(b) a transmission channel having an input location and an output location spaced apart from the input location, the channel having normal or alternating dispersion in a wavelength region containing λₒ; and

(c) means for coupling at least one pulse into the channel at the input location and means for detecting the pulse at the output location, the pulse being transmitted through the channel from the input to the output location; the pulse having a peak power and a pulse width, selected to make the pulse a parabolic pulse in at least a part of the channel, the losses in the channel resulting in a decrease of the peak power of the pulse with increasing distance from the input location, the system further comprising:

(d) a means for recompressing the dispersed pulse before detection or regeneration and/or reamplification.

We distinguish here between pulse regeneration ie a process in which at least the pulse amplitude is increased and the pulse is generally reshaped in a repeater typically involving a change in the nature of the signal carrying entity, from photons to eg electrons, and back to photons, and amplification by purely optical means.

Optical amplifiers described in the invention have potential wide-ranging applications in many areas of current optical technology, allowing the generation of well defined linearly chirped output pulses even in the presence of input pulse distortions. All of the energy of an incident pulse is converted into a parabolic pulse and the asymptotic pulse characteristics are determined only by the incident pulse energy and the amplifier parameters, with the initial pulse shape determining only the map toward this asymptotic solution. High power linearly-chirped parabolic pulses can be efficiently compressed (after compression of the parabolic pulses generated in our experiments, we have generated pulses of 80 kW peak power having 70 fs duration). The invention provides a convenient fiber-based method of generating and transmitting high-power optical pulses, rivalling soliton propagation, stretched-pulse gaussian pulse propagation, as well as existing chirped pulse amplification systems.

The principal advantage of using parabolic pulses in an optical fiber communications system lies in the potentially substantial increase in the energy of the pulses which can be transmitted. This increased energy results in an increased distance over which the data can be propagated before reamplification or regeneration is required. The use of parabolic pulses increases the length of the purely passive (optical fiber) transmission medium. In order to utilise the full potential of these parabolic pulses, it will be necessary to operate in both the nonlinear and the linear propagation regimes (the latter will apply as the pulse spreads out and becomes attenuated and the peak power consequently drops). Proper choice of the dispersion map for the transmission link will be required for optimum performance. The use of an anomalous dispersion section in the linear (latter) section of the link will recompress the pulse and this effect can be used to minimise the demands on the required pulse compressor (see section (d) above) or to eliminate it. As an example, the use of signal pulses amplified to 20 dB above the levels currently used would allow the transmission link to be extended by approximately 100 km (assuming a loss of 0.2 dB/km).

Parabolic pulses can also be used in optical communications systems in other optical components such as optical switches and routers which take advantage of their high peak power and linear chirp.

The parabolic pulses are referred to herein as similariton pulses which are asymptotic solutions of the NLSE with gain, and propagate in the amplifier self-similarly subject to exponential scaling of amplitude and temporal width. In addition, the pulses possess a strictly linear chirp. These pulses also propagate self similarly in a monomode fiber in the presence of strong nonlinear effects.

### BRIEF DESCRIPTION OF FIGURES

The invention will be further described with reference to the accompanying figures, by way of example and without intending to be limiting, wherein:

FIG. 1a shows NLSE simulation results showing the evolution of pulse amplitude as a function of propagation distance for gaussian pulses of duration 100 fs-5 ps, compared with calculated asymptotic result (see legend), and

FIG. 1b shows simulated output intensity (circles, left axis) and chirp (circles, right axis) corresponding to a 200 fs input pulse, compared with the expected asymptotic parabolic pulse results (dotted lines),

FIG. 2 is a schematic diagram of an experimental set-up used for parabolic pulse generation and measurement; pulse characterization via FROG was carried out for the pulses directly from a 3.6 m Yb:doped fiber amplifier as well as after propagation in 2 m of undoped fiber (enclosed by dashed lines),

FIG. 3a shows intensity (left axis) and chirp (right axis) for pulses directly from Yb:doped amplifier for a gain of 30 dB—the solid lines are the experimental results, compared with NLSE simulation (circles), asymptotic parabolic pulse profile (short dashes) and sech² fit (long dashes), and

FIG. 3b shows the solid lines show measured intensity and chirp after propagation through 2 m of SMF, compared with parabolic (short dashes) and sech² (long dashes) fits.

### DETAILED DESCRIPTION

The NLSE with gain in eqn (1) can be analyzed using symmetry reduction, with the solutions obtained in this way representing exact self-similar solutions which appear in the asymptotic limit (z→∞). This technique yields an asymptotic self-similar solution in the limit z→∞, provided that g≠0 and that γβ₂>0. The solution is:

A(z,T)=A₀(z){1−[T/T₀(z)]²}^{1/2} exp(iφ)(z,T)),|T|≦T₀(z), (2)

with A(z,T)=0 for |T|>T₀(z). This corresponds to a pulse with a parabolic intensity profile, and a quadratic phase given by:

φ(z,T)=3γ(2g)⁻¹A₀²(z)−g(6β₂)⁻¹T². (3)

The corresponding constant linear chirp is given by δω(T)=−∂φ(z,T)|∂T=g(3β₂)⁻¹T. In the asymptotic regime, this pulse propagates self-similarly, maintaining its parabolic shape subject to the exponential scaling of its amplitude A₀(z) and effective width parameter T₀(z) according to:

A₀(z)=0.5(gE_{IN})^{1/3}(γβ₂/2)^{-1/6} exp(gz/3)

T₀(z)=3g^{-2/3}(γβ₂/2)^{1/3}E_{IN}^{1/3} exp(gz/3), (4)

where E_{IN} is the energy of the input pulse to the amplifier. This predicts that it is only the energy of the initial pulse (and not its specific shape) which determines the amplitude and width of the asymptotic parabolic pulse. In addition all of the input energy is transformed into a parabolic pulse, with no shedding of excess energy into a continuum as occurs for soliton evolution in the anomalous dispersion regime.

The NLSE with gain has been numerically simulated. Gaussian input pulses having a range of pulse durations (FWHM) from 100 fs−5 ps, but fixed energy E_{IN}=12 pJ were propagated in a 6 m long fiber amplifier with realistic parameters corresponding to Yb:doped fiber: γ=6×10⁻³ W⁻¹m⁻¹, β₂=25×10⁻³ ps²m⁻¹, g=1.9m⁻¹.

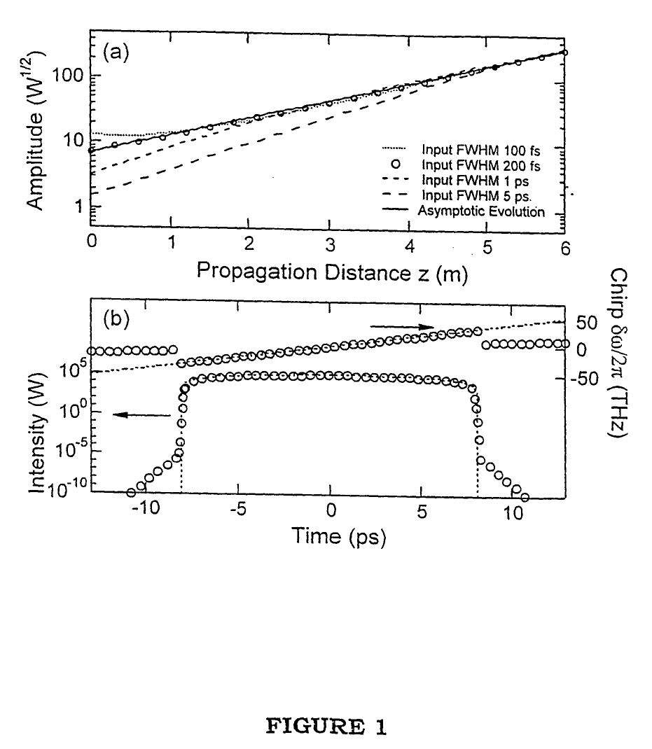

FIG. 1(a) compares the evolution of the amplitude of the propagating pulse obtained from simulations with the analytic prediction for A₀(z) given by eqn (4). The evolution of the pulse in the amplifier approaches the asymptotic limit in all cases. FIG. 1(b) shows the output pulse characteristics for the input 200 fs pulse, illustrating the excellent agreement (over 10 orders of magnitude) between the intensity and chirp of the simulation output (circles) and the expected asymptotic pulse profile from eqn (2) (dashed line). Additional simulations have been carried out to investigate the dependence on fiber parameters and pulse initial conditions in more detail. As the fiber gain is increased for a given input pulse, the exponential growth of the pulse amplitude and width is correspondingly increased in agreement with equation (4), and the parabolic asymptotic limit is reached in a shorter propagation distance. Simulations also show that for a fiber of fixed gain, the effect of intensity or phase modulation on an input pulse modifies the length scale over which the evolution to the asymptotic limit occurs, the asymptotic parabolic pulse solution is nonetheless reached in all cases after sufficient propagation distance.

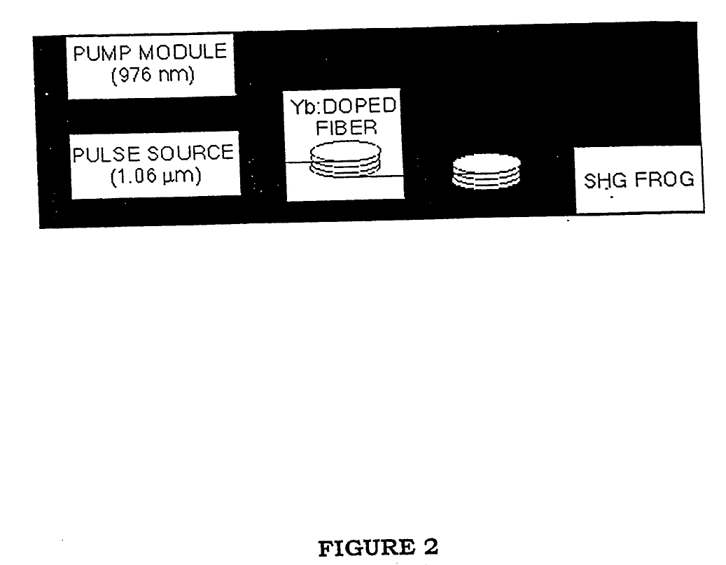

To experimentally verify that parabolic pulses are indeed generated in fiber amplifiers, femtosecond pulses were injected into a high gain Yb:doped fiber amplifier, and carried out FROG characterization of the amplified pulses. FIG. 2 shows the experimental set-up. Here, a fiber-based pulsed seed source was used to generate gaussian input pulses of 200 fs FWHM at a wavelength of 1.06 μm and at a repetition rate of 63 MHz. These pulses were then injected into a 3.6 m length of Yb:doped fiber co-directionally pumped at 976 nm, with a gain of 30 dB in this geometry. The input pulse energy in the fiber was estimated at 12 pJ. Complete pulse characterization of the output pulses was carried out using FROG based on second-harmonic generation (SHG) in a KDP crystal. FROG measurements were carried out on the pulses directly after the Yb:doped fiber amplifier, as well as after subsequent propagation in 2 m of standard undoped single mode fiber (SMF). Intensity and chirp retrieval from the measured FROG traces were carried out using the standard FROG retrieval algorithm, with the root-mean-squared error between the measured FROG trace and that associated with the retrieved pulse being acceptably low (G<0.007) in all cases.

In a generalised fiber telecommunication system according to the invention pulses of electromagnetic radiation, emitted by pulse generating means are coupled by coupling means into monomode fiber. Pulse generation is controlled by means of input signal. Since any real fiber causes attenuation of pulses transmitted therethrough, pulses arriving at a regeneration and/or amplification means are lower in amplitude and have greater width than when they were coupled into the input end of the fiber. After regeneration and/or reamplification in a regenerator and/or reamplifier, pulses continue their transit through the fiber, being periodically regenerated and/or reamplified at further regenerators and/or reamplifiers until the pulses reach the end of the transmission channel at its output end and are detected by a detecting means. Reshaping of the pulse typically takes place at regenerators during transmission. The signal derived from the detecting means contains essentially the information that has been carried by the input signal.

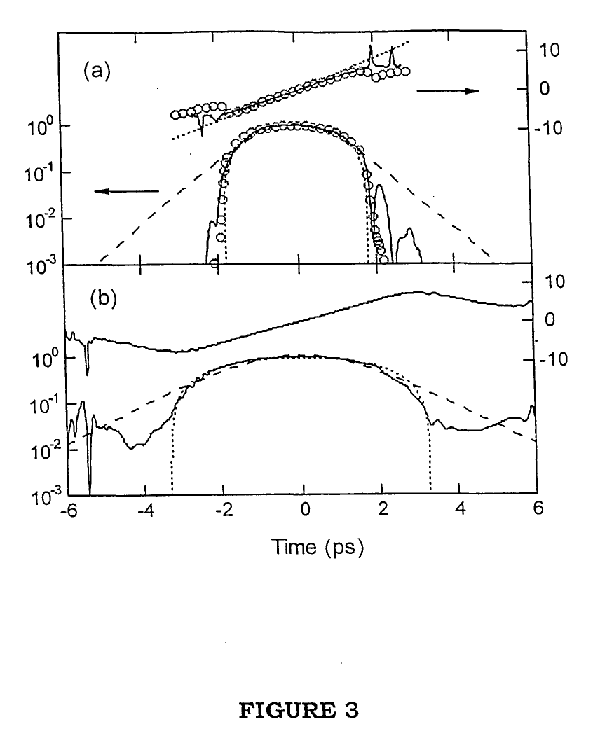

Referring to FIG. 3 the solid lines show the measured intensity and chirp for 30 dB gain in the amplifier, corresponding to a distributed gain coefficient of g=1.9 m⁻¹. In this case, the output pulse temporal FWHM was Δτ=2.6 ps, the spectral FWHM was Δτ=32 nm, and the corresponding duration bandwidth product was ΔτΔν·22. The output pulse energy was 12 nJ. The figure compares the experimental intensity and chirp with the results of NLSE simulations (circles) and the predicted asymptotic parabolic pulse characteristics (dotted lines) for this length of fiber. Both the measured intensity and chirp are in good agreement with the results of NLSE simulations. The experimentally observed weak oscillations in the wings are attributed to higher order dispersion and resonant effects not included in equation (1). More significantly, however, the measured intensity profile is also in agreement (over two orders of magnitude) with the asymptotic parabolic pulse predicted by equation (2). To emphasise the parabolic nature of these pulses, the figure also includes a sech² fit to the measured intensity profile (long dashes). These parabolic pulse characteristics are consistent with the results in FIG. 1 for a 200 fs input pulse, where asymptotic behaviour would be expected after 3.6 m of propagation.

An attractive feature of high power parabolic pulses is that they propagate self-similarly in normally-dispersive fiber, allowing for highly nonlinear propagation over substantial fiber lengths without optical wave breaking. This has been verified by launching the amplified pulses shown in FIG. 3(a) into a 2 m length of undoped single-mode fiber (SMF) and using FROG to characterize the output pulses. The output pulses after propagation had broadened both temporally and spectrally with Δτ=4.4 ps, Δλ=50.5 nm and ΔτΔν·60. FIG. 3(b) shows the measured intensity and chirp (solid lines), together with parabolic (short dashes) and sech² (long dashes) fits. The pulse intensity profile was found to remain parabolic, confirming the self-similar nature of pulse propagation, although we note that the dynamic range of the parabolic profile is reduced due to the presence of a low energy background having its origin in the weak oscillations in the wings of the amplified pulses. Importantly, despite the significant temporal and spectral broadening in this regime, the chirp is observed to remain linear, a unique feature of parabolic pulse propagation. To demonstrate the potential of high power parabolic pulses in ultrafast optics, we used a simple dispersive grating pair to compress these parabolic pulses, obtaining a minimum pulse duration of Δτ=68 fs with a corresponding peak power of 80 kW. The pulses do not compress to the expected transform limited pulse duration of around 30 fs because of third order dispersion in the bulk grating compressor, but we note that this should be eliminated with an improved compressor design.

The foregoing describes the invention including a preferred form thereof. Alterations and modifications as will be obvious to those skilled in the art are intended to be incorporated within the scope hereof as defined in the accompanying claims.

1. A method of communicating between two devices including transmitting a series of pulses over an optical medium between a first device and a second device including amplifying the pulses in an optical amplifier having a characteristic generally described by the NLSE with gain to yield parabolically shaped pulses.

2. A method of communicating between two devices according to claim 1 further including passing the pulses through at least one amplifier/regenerator arranged between the two devices attached to the optical medium through which the pulses pass and arranged to reshape/regenerate the pulses.

3. A method of communicating between two devices according to claim 1 or claim 2 further including providing incident pulses to the first device and converting the incident pulses into parabolic pulses in the amplifier.

4. A method of optical communication including providing pulses to the input of an optical source having an output characteristic generally described by the NLSE with gain such that parabolic output pulses are formed and coupling the optical source to the input end of an optical communications medium and allowing the pulses produced by the optical source to propagate over the optical medium to at least one amplifier, regenerator or receiver.

5. A method of optical communication according to any one of claims 1 to 4 including modulating the energy in the input pulses to vary the amplitude and period of the output pulses.

6. A method according to any one of claims 1 to 5 including compressing the parabolic pulses after transmission over the optical medium, and then amplifying the pulses.

7. A method of optical communication according to any one of claims 1 to 6 wherein the optical communications medium is an optical fiber communication channel along a single mode optical fiber, and the transmitted pulses are comprised of electromagnetic radiation of wavelength λₒ where λₒ is a wavelength in the anomalous dispersion regime of the fiber.

8. A pulse generator having a characteristic generally described by the NLSE with gain arranged to generate parabolic output pulses from incident pulses.

9. An optical amplifier having a characteristic generally described by the NLSE with gain arranged to generate parabolic output pulses from incident pulses

10. An optical amplifier according to claim 9, which is any of:
(a) a glass amplifier and pumped with electromagnetic radiation adapted to producing a population inversion in the energy levels;
(b) a Raman amplifier in which λₒ is within a “Stokes” wavelength band of pump radiation;
(c) an amplifier arranged to inject a continuous wave of wavelength essentially equal to λₒ, in phase with the parabolic pulse(s) and of amplitude substantially lower than the pulse amplitude to increase the pulse amplitude through nonlinear interaction between pulse and the continuous wave; and
(d) a semiconductor laser operated as an amplifying medium.

11. An optical amplifier according to claim 10 which is a glass amplifier pumped with electromagnetic radiation to produce a population inversion in the energy levels, including a glass medium doped with an ion species having energy levels separated by an energy substantially equal to hc/λₒ, where h is Planck's constant and c is the speed of light in vacuum.

12. An optical amplifier according to any one of claims 9 to 11 arranged to generate linearly chirped parabolic output pulses from incident input pulses

13. An optical amplifier according to any one of claims 9 to 12 arranged to generate linearly chirped parabolic output pulses even in the presence of input pulse distortions.

14. An optical amplifier according to any one of claims 9 to 13 including an associated compression stage arranged to subsequently compress the parabolic pulses.

15. An optical telecommunication system including:
(a) a source of pulses of electromagnetic radiation of carrier wavelength λₒ;
(b) a transmission channel having an input location and an output location spaced apart from the input location, the channel having normal or alternating dispersion in a wavelength region containing λₒ; and
(c) means for coupling at least one pulse into the channel at the input location and means for detecting the pulse at the output location, the pulse being transmitted through the channel from the input to the output location; the pulse having a peak power and a pulse width, selected to make the pulse a parabolic pulse in at least a part of the channel, the losses in the channel resulting in a decrease of the peak power of the pulse with increasing distance from the input location, the system further comprising:
(d) a means for recompressing the dispersed pulse before detection or regeneration and/or reamplification.

16. An optical telecommunication system according to claim 15 further including at least one regenerator/amplifier arranged to receive the pulses and increase the amplitude and decrease the width of the pulses and then retransmit the pulses.

17. An optical telecommunication system according to claim 15 or claim 16 in which the transmission channel is a single mode optical fibre having loss at the wavelength λₒ.

18. An optical switch having a characteristic described by the NLSE with gain.

19. A router having a characteristic described by the NLSE with gain.

20. An optical telecommunication system according to claim 15 or claim 16 further including at least one switch or router.
